(19) United States
(12) Patent Application Publication
(10) Pub. No.: US 2018/0018364 A1
(43) Pub. Date: Jan. 18, 2018

(54) COMMON ANALYTIC FRAMEWORK AND ENVIRONMENT FOR BIG DATA ANALYTICS

(71) Applicant: HITACHI, LTD., Tokyo (JP)

(72) Inventors: Chetan GUPTA, San Mateo, CA (US); Song WANG, Mountain View, CA (US); Kunihiko HARADA, San Jose, CA (US); Umeshwar DAYAL, Saratoga, CA (US)

(21) Appl. No.: 15/543,082

(22) PCT Filed: Mar. 31, 2015
(86) PCT No.: PCT/US15/23694

§ 371 Date: Jul. 12, 2017

(51) Int. Cl. G06F 17/30; G06F 3/0484; G06F 11/34; G06F 3/0481

(52) U.S. Cl. CPC G06F 17/30398; G06F 17/30592; G06F 17/30539; G06F 3/04817; G06F 3/0484; G06F 11/3466

(57) ABSTRACT

Systems and methods are directed to providing one or more interfaces to construct a flow and dashboard for data sources connected to an apparatus. In example implementations, a flow building interface and a dashboard designing interface is provided. The interfaces produce flow information and dashboard information, which is used by the apparatus to construct a dashboard, execute a plurality of flows and receive data from one or more external sources to execute the dashboard.

### BACKGROUND

### Field

The present disclosure is directed to data analytics, and more specifically, to a common analytic framework and environment for big data analytics.

### Related Art

Recently big data has gotten a lot of attention. Organizations have expectation on the big data because they think many insights can be derived from the data. More specifically in the case of operation technology (OT) industries such as mining, oil & gas, and power, companies have been collecting huge amount of data from their equipment and processes. The companies would like to leverage this data so that they derive useful knowledge and improve efficiency and productivity. The demand for such applications that can convert the data collected into useful knowledge is across verticals.

The related art approach to meeting this demand is to create solutions from industry to industry.

This approach has several drawbacks: Firstly, the development process is inefficient, slow, and expensive since developers have to build from scratch every time Secondly, the knowledge learned from development for a domain is hard to be leveraged for development for another domain Finally, resulting analytics applications tend to be incomplete because application development process is mainly done by engineers and the domain experts are left out of the process. Although domain specialists have expertise in the domains they belong to, building these applications requires a lot of information technology (IT) expertise such as data management, statistics, data mining, machine learning, operations research, combinatorial optimization, and so on.

Another perspective is that the separation of application users, developers and designers in terms of application development is not optimal. There is a need for an environment that enables application users (domain experts), IT developers and designers together to quickly build such applications.

### SUMMARY

The present disclosure is directed to a device and a method that relate to big data analytics. In example implementations, there is a common analytic framework and environment for efficiently developing and prototyping analytics applications.

The present disclosure is directed to assisting domain and IT experts to build a completed application that includes algorithms working in backend and dashboards providing visualization of the results of the algorithms.

Aspects of the present disclosure include a method, which may involve providing a first user interface configured for construction of flow information representative of a plurality of flows, the plurality of flows including a plurality of analytics operators selected from a library of pre-existing operators through the first user interface, the library of pre-existing operators comprising a first type of operator configured for general analytics operations, and a second type of operator configured for industry analytics operations; providing a second user interface configured to generate dashboard information to handle the plurality of flows; generating a dashboard from the dashboard information and the flow information, the dashboard configured to be constantly updated from streaming or periodic input from one or more sources; parsing the plurality of analytics operators selected from the first type of operators configured for the general analytics operations and the second type of operators configured for the industry analytics operations from the flow information to execute the plurality of flows; and presenting results of the execution of the plurality of flows on the generated dashboard.

Aspects of the present disclosure include a computer program, storing instructions for executing a process, the instructions including providing a first user interface configured for construction of flow information representative of a plurality of flows, the plurality of flows including a plurality of analytics operators selected from a library of pre-existing operators through the first user interface, the library of pre-existing operators comprising a first type of operator configured for general analytics operations, and a second type of operator configured for industry analytics operations; providing a second user interface configured to generate dashboard information to handle the plurality of flows; generating a dashboard from the dashboard information and the flow information, the dashboard configured to be constantly updated from streaming or periodic input from one or more sources; parsing the plurality of analytics operators selected from the first type of operators configured for the general analytics operations and the second type of operators configured for the industry analytics operations from the flow information to execute the plurality of flows; and presenting results of the execution of the plurality of flows on the generated dashboard. The instructions may be stored in a non-transitory computer readable medium that can be executed by one or more processors.

Aspects of the present disclosure include an apparatus communicatively coupled to a network and one or more sources, the apparatus including a storage configured to store flow information and dashboard information; and a processor, configured to: provide a first user interface configured for construction of the flow information representative of a plurality of flows, the plurality of flows including a plurality of analytics operators selected from a library of pre-existing operators through the first user interface, the library of pre-existing operators comprising a first type of operator configured for general analytics operations, and a second type of operator configured for industry analytics operations; provide a second user interface configured to generate the dashboard information to handle the plurality of flows; generate a dashboard from the dashboard information and the flow information, the dashboard configured to be constantly updated from streaming or periodic input from the one or more sources; parse the plurality of analytics operators selected from the first type of operators configured for the general analytics operations and the second type of operators configured for the industry analytics operations from the flow information to execute the plurality of flows; and present results of the execution of the plurality of flows on the generated dashboard.

### BRIEF DESCRIPTION OF DRAWINGS

FIG. 1 illustrates an example computing device upon which example implementations may be implemented.

FIG. 2 illustrates an example interface for flow construction for the application builders, in accordance with an example implementation.

FIG. 3 illustrates an example of a process diagram for flow construction in accordance with an example implementation.

FIGS. 4 to 11 illustrate an example interface and interactions for dashboard construction in accordance with an example implementation.

FIG. 12 illustrates a flow diagram for dashboard construction, in accordance with an example implementation.

FIGS. 13(a) to 13(c) illustrates an example flow for executing the application use phase in accordance with an example implementation.

FIG. 14(a) illustrates an example of a metadata store, in accordance with an example implementation.

FIG. 14(b) illustrates an example of an operator definition store, in accordance with an example implementation.

FIG. 15 illustrates an example system upon which example implementations may be implemented.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

The present disclosure facilitates an application development environment using a device/method having a storage unit storing metadata, a storage unit storing common analytics, a flow building unit, a dashboard designing unit, a flow compilation unit, a flow execution unit, a dashboard compilation unit, and a dashboard execution unit. In example implementations, the device and method for building big data analytics applications utilizes a storage unit storing operator components enabling commonly used operations; a flow building unit that facilitates the creation of an analytic application flow, by using flows nodes chosen form the operator components; a dashboard designing unit that facilitates the creation of dashboards by letting an application designer specify where to show visualization, what to show for the visualization, and what data to bind to the visualization; a flow compilation unit that transforms the flows built by human to flows runnable in backend; a flow execution unit that runs the transformed flows in backend; a dashboard compilation unit that transforms the information specified using the dashboard designing unit to dashboards that can run in backend; a dashboard execution unit that runs the transformed dashboards and shows them to users of the built analytics applications; and a storage unit storing metadata that are created during all the intermediate states described above.

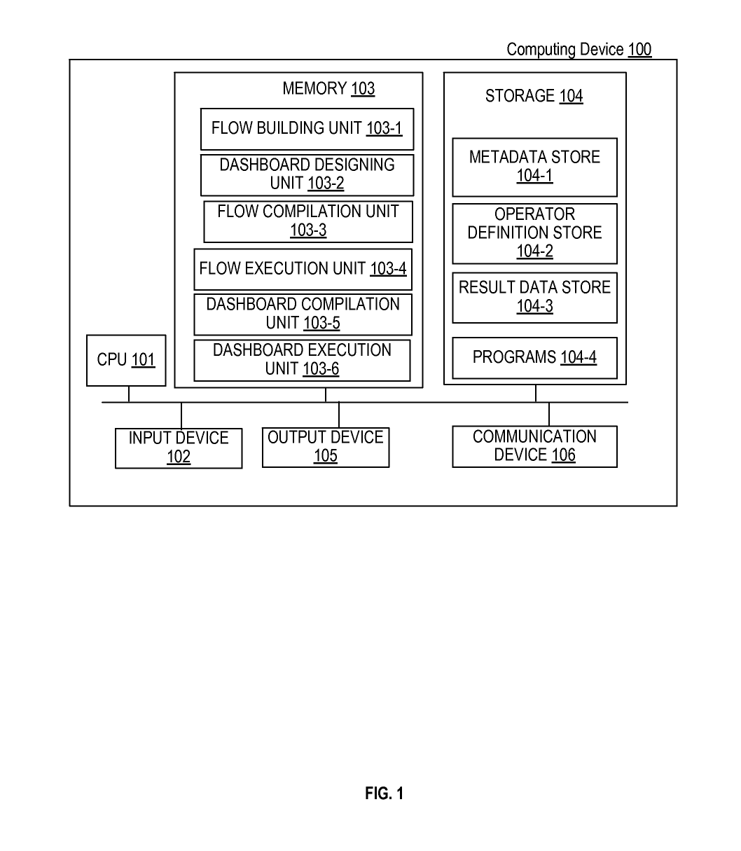

A configuration example of a device that implements a technology of a first embodiment will be described with reference to FIG. 1. Lets assume that application builders develop a big data analytics application. Note that a developer that develops analytics algorithms and a developer that defines how to visualize results of the algorithms might be different or might be the same entity.

FIG. 1 illustrates an example computing device upon which example implementations may be implemented. The computer device is an information processing device such as a personal computer (PC), server, or a workstation. The computer includes a central processing unit (CPU) 101, an input device 102, a memory 103, a storage 104, an output device 105, and a communication device 106, which are connected to each other via an internal communication line such as a bus.

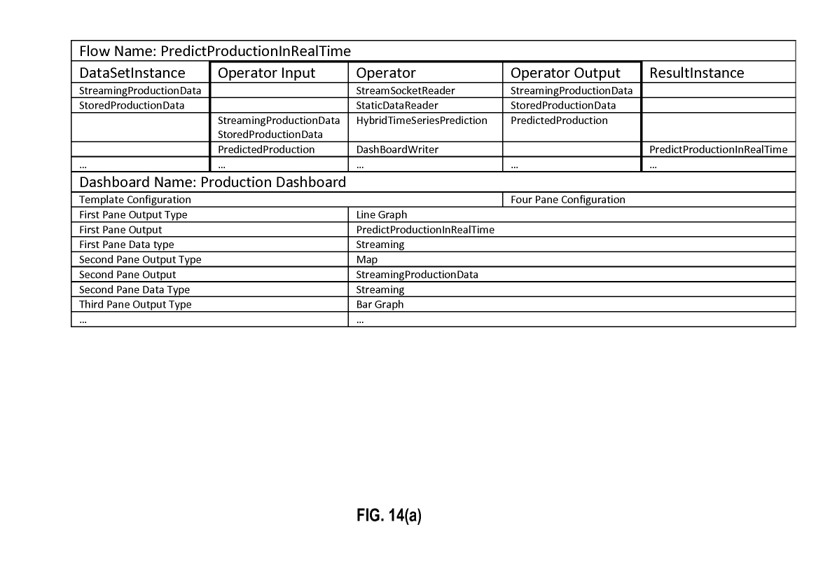

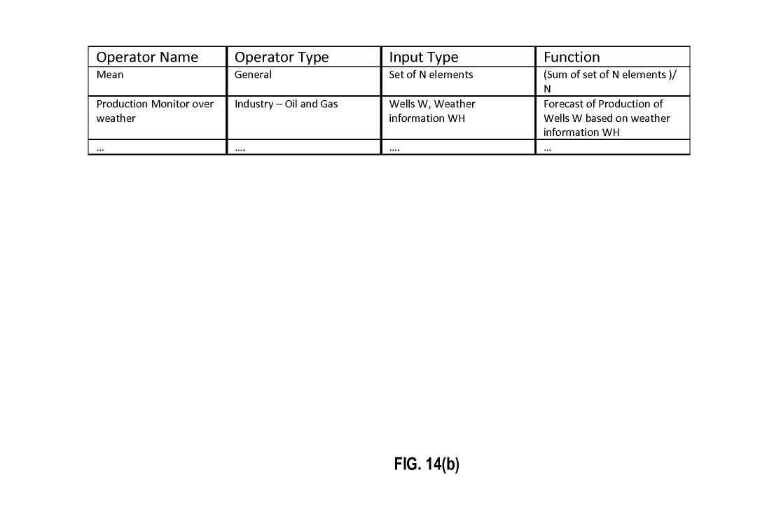

The storage 104 is, for example, a storage media such as a compact disc recordable (CD-R), a digital versatile disk random access memory (DVD-RAM), or a silicon disk, a driving device of the storage media, or a hard disk drive (HDD). The storage 104 stores a metadata store 104-1, an operator definition store 104-2, a result data store 104-3, and one or more programs 104-4. The metadata store 104-1 stores metadata which can include multiple kinds of metadata. Examples include metadata for flows, compiled flows, and dashboards are stored in the form of dashboard information and flow information as described in FIG. 14(a). The operator definition store 104-2 stores definitions of operators. Each operator stands for an algorithm or a block of algorithms such as “Clustering” or “Predictive Maintenance”. The result data store 104-3 temporarily stores result data of analytics algorithms. The programs 104-4 implement the functions which will be described below.

The input device 102 is any device for input, such a keyboard, a mouse, a scanner, or a microphone and so on. The output device 105 can include a display, a printer, or a speaker. The communication device is, for example, a local area network (LAN) board and is connected to a communication network (not illustrated).

The CPU 101 load the programs 104-4 in the memory 103 and executes the programs 104-4 to implement a flow building unit 103-1, a dashboard designing unit 103-2, a flow compilation unit 103-3, a flow execution unit 103-4, a dashboard compilation unit 103-5, and a dashboard execution unit 103-6.

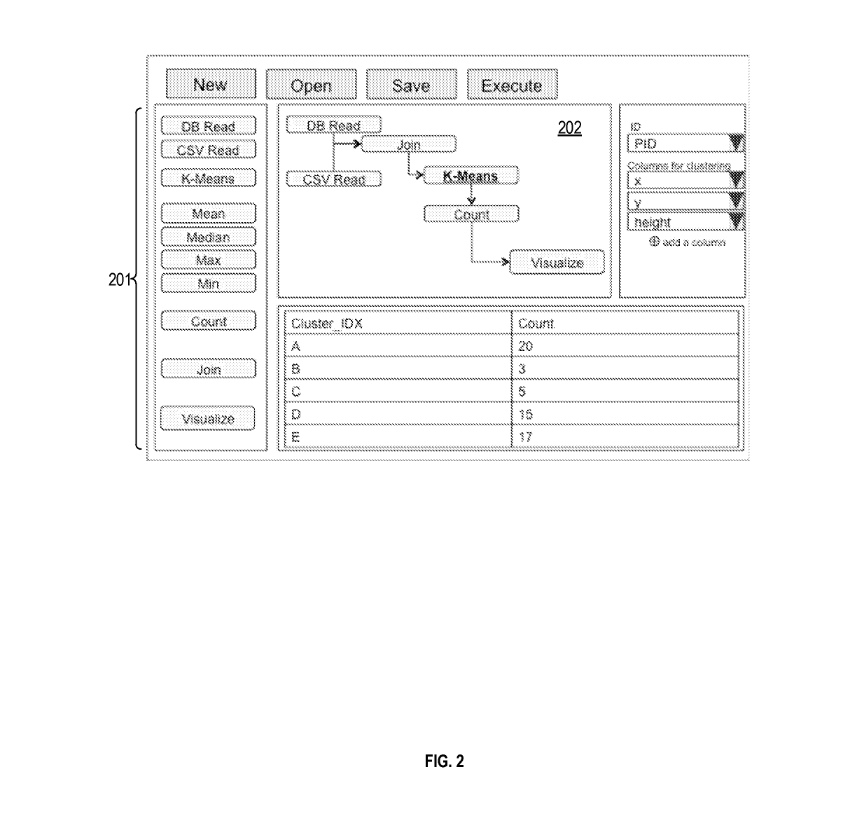

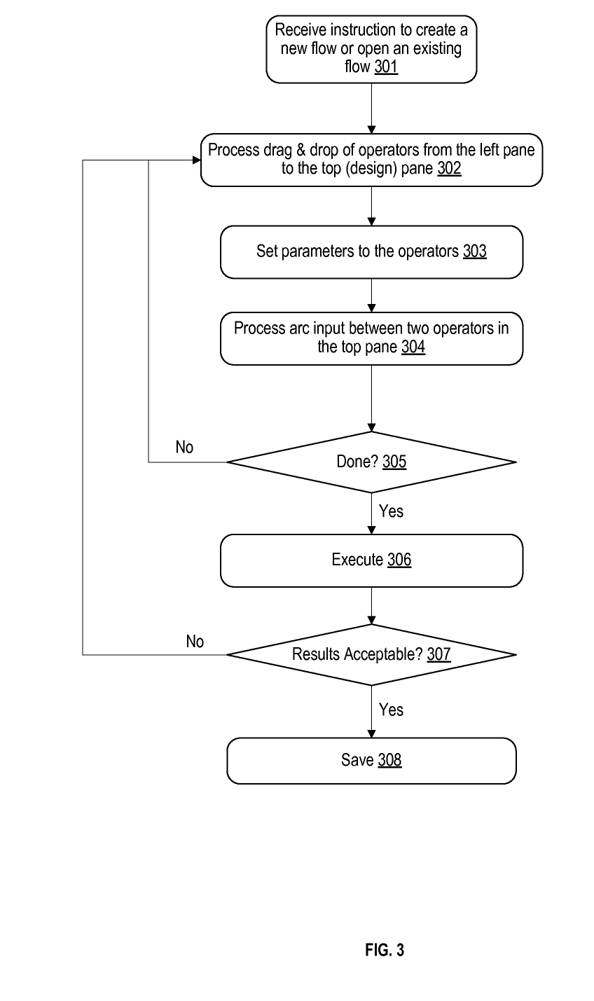

The flow building unit 103-1 is configured to enable interaction with the application builder using a graphical user interface (GUI) and lets the application builder create flows. The flow building unit 103-1 stores the created flows in the metadata store 104-1. The flow building unit is also able to render a pre-built flow in accordance with an order from the application builders and letting the application builders edit the pre-built flow. An interaction example will be described with respect to FIGS. 2 and 3.

The dashboard designing unit 103-2 is configured to enable interaction with the application builders using a graphical user interface (GUI) and facilitates the creation of dashboards, which will eventually be compiled into visualization of the created flows. The dashboard designing unit 103-2 stores the created dashboards in the metadata store 104-1 as dashboard information. The dashboard designing unit is also configured to render pre-built dashboards in accordance with an order from the application builders and to let the application builders edit the pre-built dashboards. An interaction example will be described below.

The flow compilation unit 103-3 is configured to get the flows stored in the metadata store 104-1 by the flow building unit 103-1, compile the flows, and store the compiled flows to the metadata store 104-1. These compiled flows correspond to the analytics algorithms.

The flow execution unit 103-4 is configured to get the compiled flows stored in the metadata store 104-1 by the flow compilation unit 103-1, run the compiled flows, and store results in the result data store 104-3.

Here the flow compilation unit 103-3 and the flow execution unit 103-4 are described as separate units, but they can also be combined as one unit that consumes the flows stored in the metadata store 104-1, compiles them, and runs the compilation results without storing them. Hereafter it is assumed for simplicity that the flow execution unit 103-4 does the role of the flow compilation unit 103-3 as well.

The dashboard compilation unit 103-5 is configured to obtain the dashboard stored in the metadata store 104-1 by the dashboard designing unit 103-5, compile the dashboards, and store the compiled dashboards to the metadata store 104-1. The compiled dashboards can be for example HyperText Markup Language (HTML) files, javascript files, stylesheet files, and/or any combination of such files.

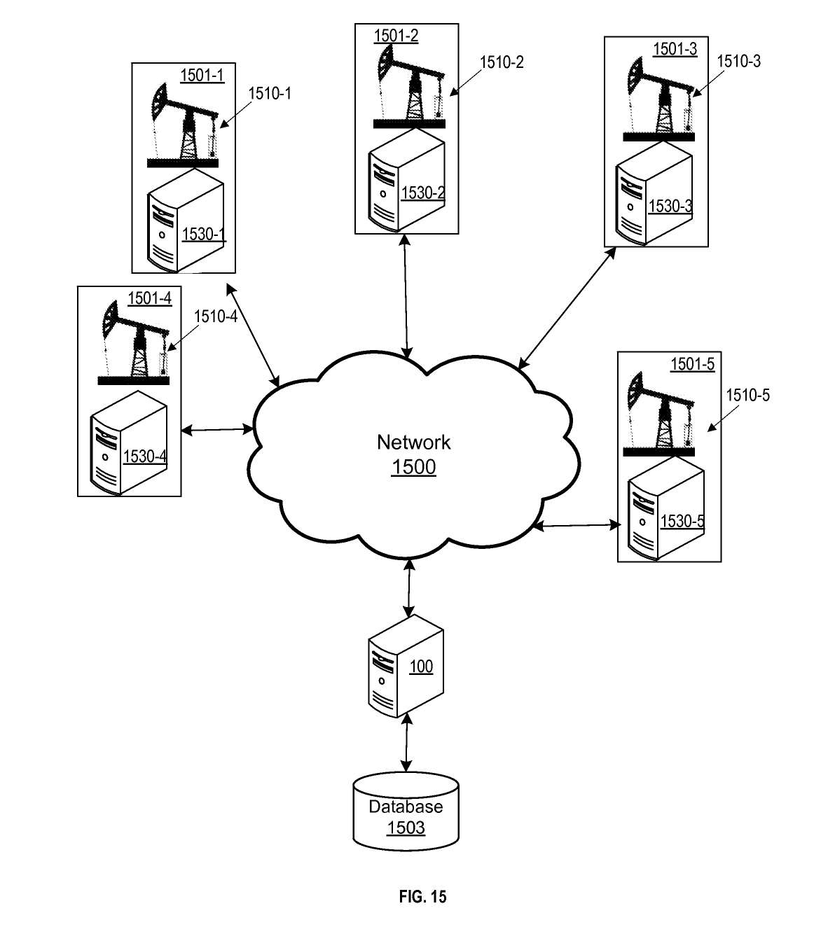

The dashboard execution unit 103-6 gets the compiled dashboards stored in the metadata store 104-1 by the dashboard compilation unit 103-5, executes the compiled dashboards, and shows visualization to the application users. In this process, the dashboard execution unit 103-6 may ask the flow execution unit 103-4 to execute the compiled flows that are needed for showing the analytics results, or the flow execution unit 103-4 may execute the needed compiled flows in advance in another way. The dashboard execution unit 103-6 can be implemented, for example as a webserver. The dashboard execution unit 103-6 is configured to generate a dashboard from the dashboard information and the flow information of the metadata store 104-1. The dashboard execution unit 103-6 constructs the dashboard to be configured to be constantly updated from streaming or periodic input from the one or more sources as illustrated in FIG. 15. Depending on the flows constructed and defined in the flow information, the external sources can be queried by the dashboard in real time as streamed data, as periodic data over time intervals defined in the flow information, or even a set number of times (e.g., once) depending on the desired implementation.

Here the dashboard compilation unit 103-5 and the dashboard execution unit 103-6 are described as separate units but it is also applicable to have one unit that consumes the dashboards stored in the metadata store 104-1, compiles the dashboards, and runs the compilation results without storing them. Hereafter it is assumed for simplicity that the dashboard execution unit 103-6 does the role of the dashboard compilation unit 103-5 as well.

In FIG. 1, it is assumed that all the needed units are implemented in the memory in the same computing device, but it is also applicable to implement the units in multiple different computing devices and the units communicate one another through the communicating device. Moreover the application builders and the application users may see the GUI and/or the visualization using another computing device that is connected to the computing device implementing the units through the communication device.

An example implementation of the overall interaction for building an analytics application as follows. Firstly, the application builders create single or multiple flows using the flow building unit 103-1. Secondly, the application builders create a dashboard using the dashboard designing unit 103-2. Lastly, the application builders make the built flows and the built dashboard run. Details of each interaction will be described below.

In example implementations as described in FIG. 2 and FIG. 3, an example of interaction by which the application builders construct the flows using the flow building unit will be described.

FIG. 2 illustrates an example interface for flow construction for the application builders, in accordance with an example implementation. FIG. 3 illustrates an example of a process diagram for flow construction in accordance with an example implementation. At first, the flow building unit 103-1 receives instructions through the interface as illustrated in FIG. 2 to either create a new flow or open an existing flow 301 through the interface as illustrated in FIG. 2. When the application builders choose the new flow creation through the interface, the flow building unit 103-1 facilitates the receipt of parameters of the flow through the interface (e.g., name of the flow, etc.). This process for giving a name of the flow may be done any time in the processes before “Save” process described here.

In the left pane 201 as shown in the example of FIG. 2, the flow building unit 103-1 shows all the operators defined in the operator definition store 104-2 through the interface. FIG. 2 shows an example in which a column for ID and columns for clustering operation are selected for “K-Means” operator. From the operators shown in the left pane 201, the application builders can drag and drop operators to the top (design) pane 202 which is processed by the flow building unit 103-1 as shown at 302 of FIG. 3. For the selected operators, the application builders can set parameters that each operator requires, which is processed by the flow building unit 103-1 at 303 of FIG. 3. The flow building unit 103-1 also processes, at 304, input where application builders draw an arc from an operator node to another operator node if the two operator nodes allow such a connection. The direction of the arc stands for where the data output from the former node should go. These two processes (setting parameters and drawing arcs) may be done in any order.

The user interface of FIG. 2 is configured for construction of the flow information representative of one or more flows as desired by the application builders as shown at design pane 202. As illustrated in the design pane 202, each of the flows includes analytics operators selected from a library of pre-existing operators through the user interface from the left pane 201. The library of pre-existing operators may include several types of operators, including operators for general analytics operations, and operators for industry analytics operations.

The library of pre-existing operators can be managed in the operator definition store 104-2, to include the general analytics operations and industry analytics operations. General analytics operations can include any analytics operators known in the art, such as K-means, median, and so on.

The industry analytics operations can include operators such as predictive maintenance, operation optimization, production monitoring, supply chain optimization, and production optimization, and so on. For example, the predictive maintenance operator takes in as input sensor data and event data, and outputs prediction a failure event(s). Similarly, for example, a production monitoring operator consumes as input streaming sensor data and outputs significant events such as decline in production from historical averages, reduction in the number of available equipment and so on. Supply chain optimization can include taking streaming input regarding the supply chain, and outputting events where the supply chain is undergoing a bottleneck with respect to a threshold. Production optimization can take in production outputs from systems such as oil and gas systems, and provide suggestions based on data analytics.

The one or more programs 104-4 can include a library management utility configured to manage the pre-existing operators of the library and to add new operators, as well as manage the industry analytics operations and the general analytics operations. The library management utility can include an interface that allows the application builders to define new operators or edit operators stored in operator definition store 104-2. This can facilitate the additions of industry analytics operations that the application builder can define to be applicable to the industry of interest to the application builder as illustrated in FIG. 14(b). For example, when working with data from building energy management systems, the application builder can add a new operator for “Detecting Performance Deterioration” that detects a deterioration of performance of various sub-components that make up the building energy management system.

The flow building unit 103-1 may inform the application builders through the interface that there are errors in the flow they are building by compiling/executing the flow seamlessly in the backend at 306, or they can be executed for receipt of a command that flow construction is done at 305 (Yes). Otherwise (No) the interface can permit the application builders to continue construction of additional flows. A flow can have single or multiple special operator nodes named “Visualize”. This operator node means that the data the node receive is going to be sent to build dashboards eventually. The application builders can check if they like the results coming from the “Visualize” operator nodes by clicking “Execute” button. The results coming from the “Visualize” operator nodes are shown in the bottom pane in FIG. 2. If the flow building unit 103-1 receives an indication through the interface that the application builders finds the results to be acceptable at 307 (Yes), the flow can be saved as the final version at 308, otherwise (No), the flow can continued to be edited. Besides building the flow, the application builders may also specify the execution frequency of the flow which can be one of: (i) Once, (ii) Periodically, (specified by the application builders as to how often the flow is to be executed) and (iii) Continuous (e.g. streaming).

After this, the flow is saved in the metadata store 104-1 in any format. Further, the interface of the blow building unit 103-1 may also be configured to display results of the flow being configured by communicating with the one or more data sources over a network as illustrated in FIG. 15. In this implementation, the application builders can therefore compile and view results of the flow to ensure correctness before implementation into a dashboard.

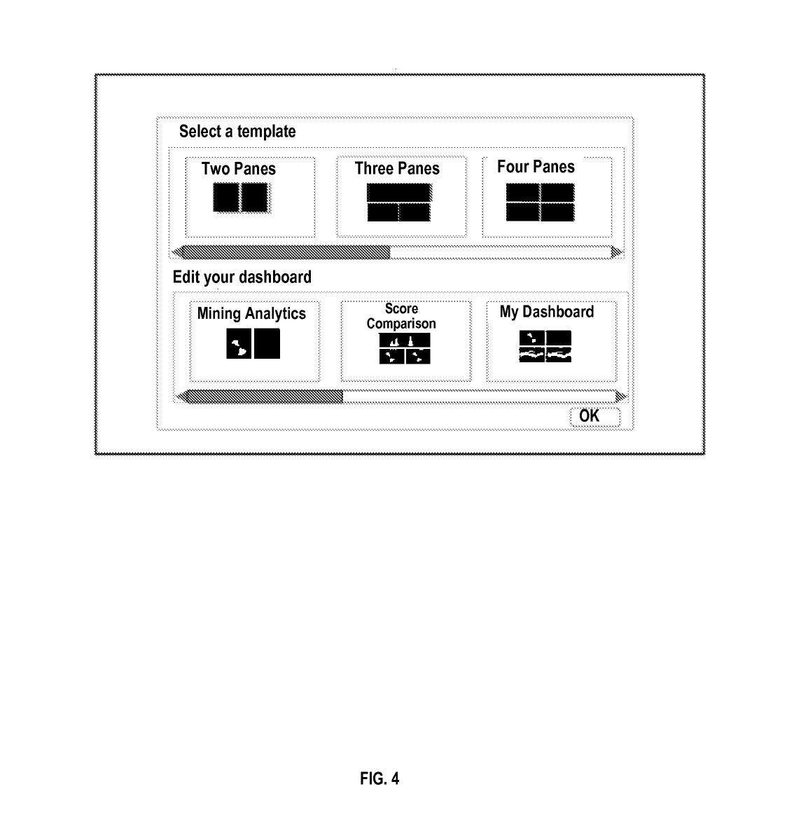

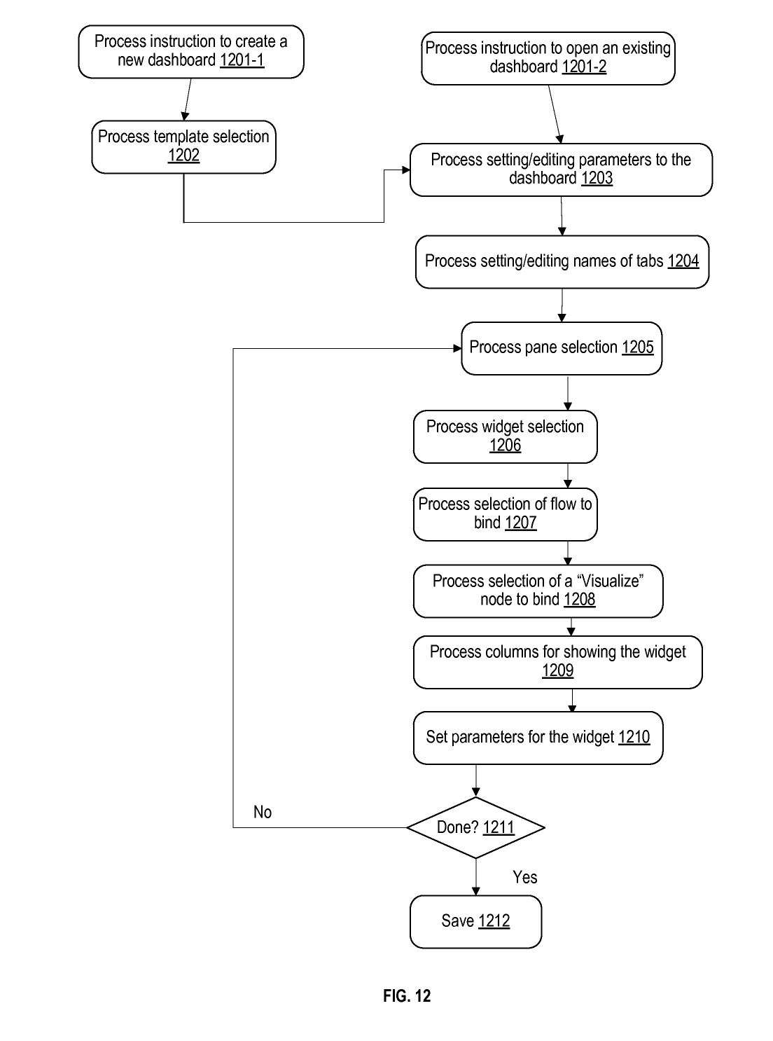

FIGS. 4 to 11 illustrate an example interface and interactions for dashboard construction in accordance with an example implementation. FIG. 4 to FIG. 11 illustrate an example of interaction by which the application builders construct the dashboard (visualization of the flow results) using the interface dashboard designing unit 103-2, and is described with respect to the flow diagram of FIG. 12. The dashboard designing unit 103-2 facilitates an interface configured to generate the dashboard information of the metadata store 104-1 to handle the plurality of flows defined in the flow information of the metadata store 104-1. The dashboard designing unit 103-2 facilitates a user interface configured to generate the dashboard information by providing a widget selection user interface; providing a flow selection user interface; providing an output operator user interface; and providing a widget configuration user interface as illustrated below.

FIG. 12 illustrates a flow diagram for dashboard construction, in accordance with an example implementation. At first, the dashboard designing unit 103-2 processes an instruction through the interface to either “create a new dashboard” at 1201-1 as illustrated in FIG. 4 or “open an existing dashboard” at 1201-2. In the case of executing “create a new dashboard” at 1201-1, the dashboard designing unit 103-2 processes a selection of a template from the application builders from pre-defined templates at 1202. A template defines visualization settings other than visualization of the flow results. For example, a template may describe the division of screens into panes, the number of tabs per pane, and the division of each tab into panes. These template definitions may be stored in the metadata store 104-1. FIG. 4 illustrates an interface for selecting templates on a dashboard.

Further, the one or more programs 104-4 can include a template management utility configured to manage dashboard configuration templates through the interface facilitated by the dashboard designing unit 103-2. The template management utility enables application builder to add, edit or delete dashboard templates available to application builders.

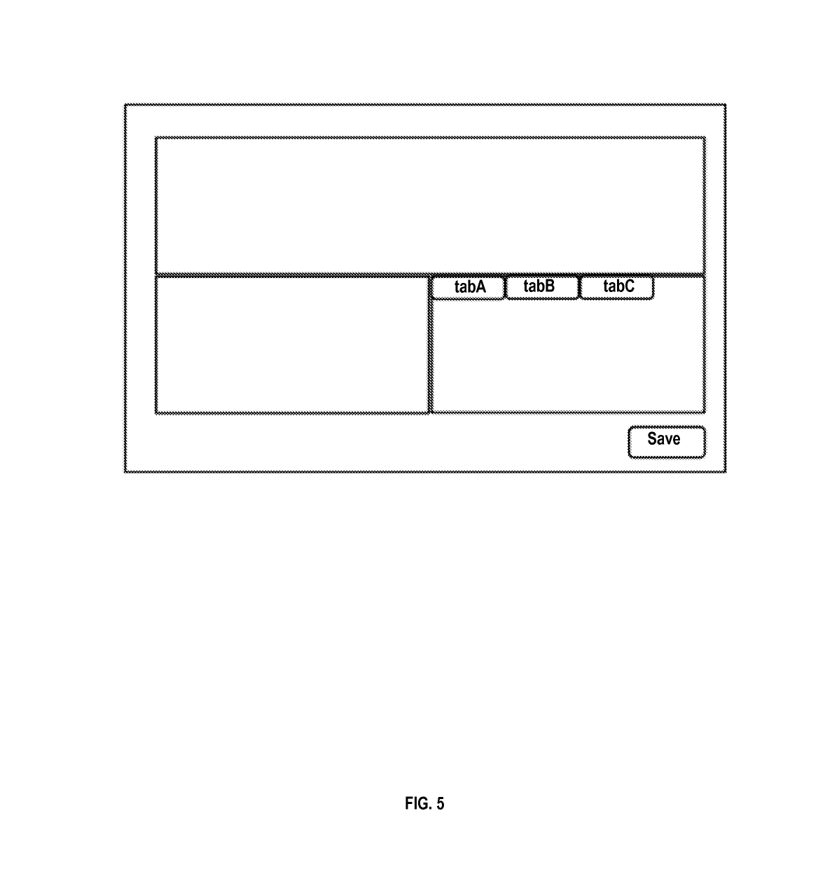

Through this GUI provided by the dashboard designing unit, the application builders are able to create a new dashboard by selection a template as shown at 1202 or to edit an existing dashboard as shown at 1201-2. The templates and the dashboards listed are read from the metadata store 104-1. By selecting “OK” button, the application builders can move on to the next aspect of the interface as illustrated in FIG. 5 to set or edit the parameters of the dashboard at 1203.

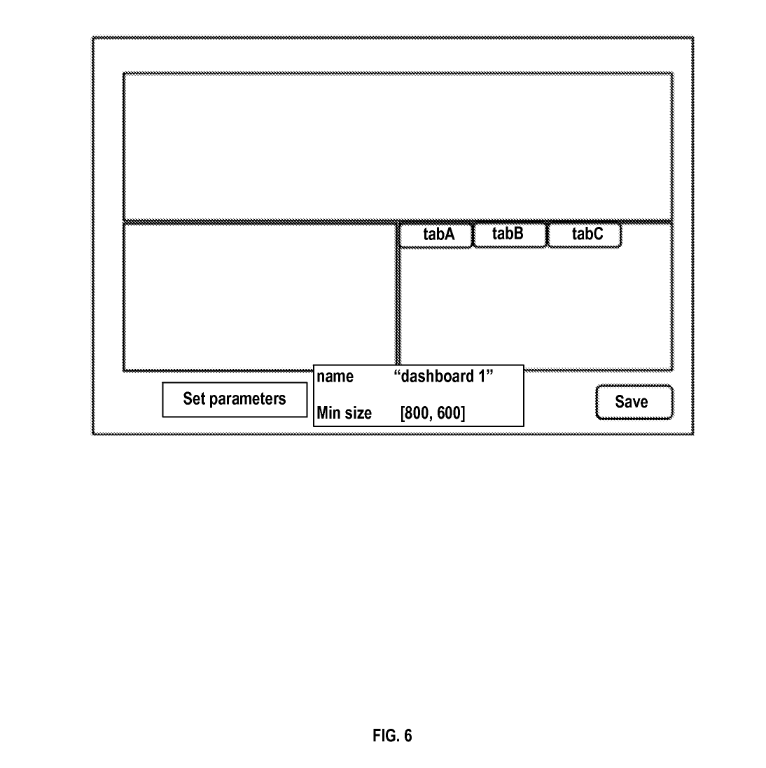

The dashboard designing unit 103-2 provides an interface for the setting of parameters at 1203 to the dashboard in the case of “create a dashboard” as shown at 1201-1. In the case with editing an existing dashboard from 1201-2, the interface provided by the dashboard designing unit 103-2 may facilitate the editing parameters previously set. FIG. 6 illustrates an example of a GUI that the dashboard designing unit 103-2 provides through the interface. When the application builders select the white space area in the interface (e.g. outside from the template layout) shown in FIG. 5, a popup window is deployed and the application builders can input the parameters into the popup window. Here the parameters are, for example, a name of the dashboard and minimum size of resolution used for visualizing the dashboard.

The dashboard designing unit 103-2 provides an interface for processing the setting or editing of names of tabs for the dashboard at 1204. For example by selecting a tab, the dashboard designing unit 103-2 enables the dashboard builders to change the name of the tab.

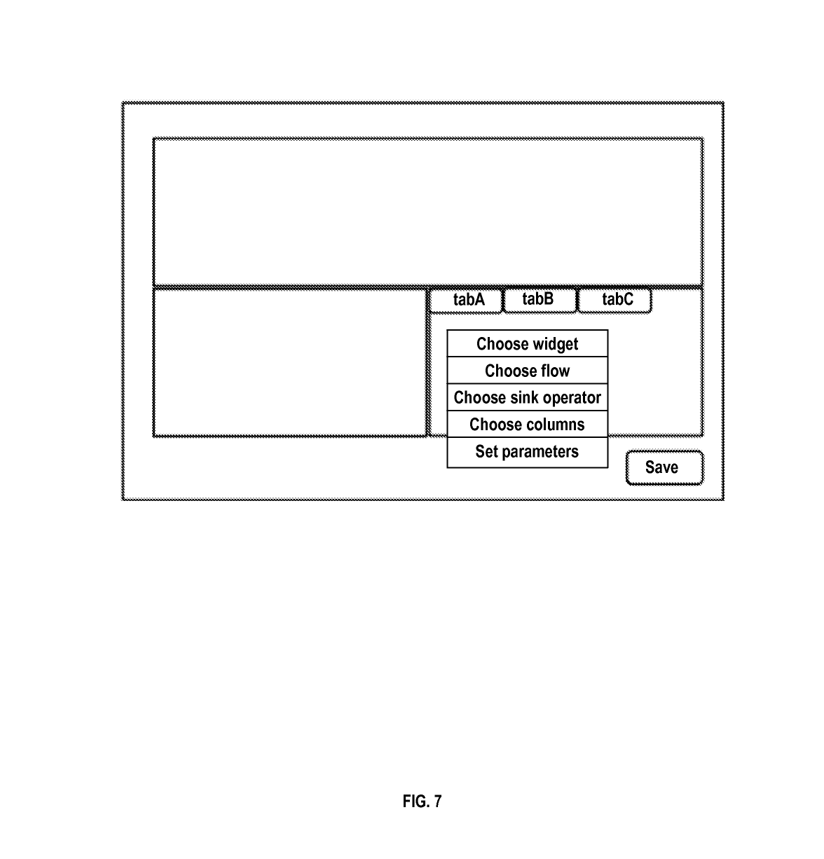

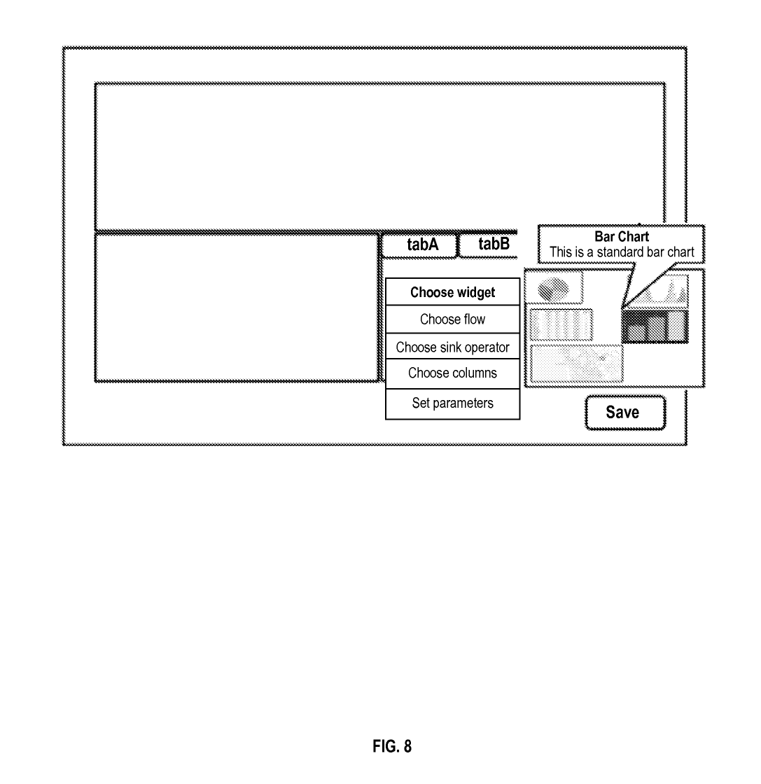

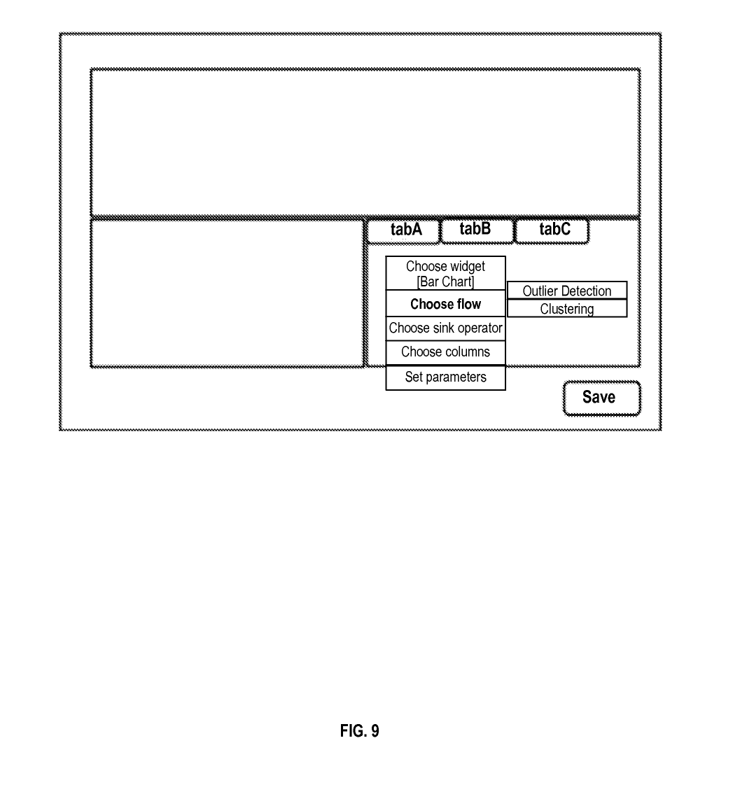

The application builders set a widget to each pane that does not include tabs inside at 1206. FIGS. 7 to 11 illustrate an example of the interaction. When the application builders choose a pane, the process unit processes the pane selection at 1205, a popup menu is deployed, which provides a widget selection user interface. By selecting the first choice of the popup menu as illustrated in FIG. 7, the dashboard designing unit 103-2 can facilitate an interface for widget selection 1206 for the selected pane as illustrated in FIG. 8. Here a widget can be for example a map widget, which shows provided data as locations, a bar chart, a pie chart, a table, and so on. Next, the dashboard designing unit 103-2 facilitates a selection of a flow at 1207, as shown with the selection of the second choice of the popup menu as illustrated in FIG. 9.

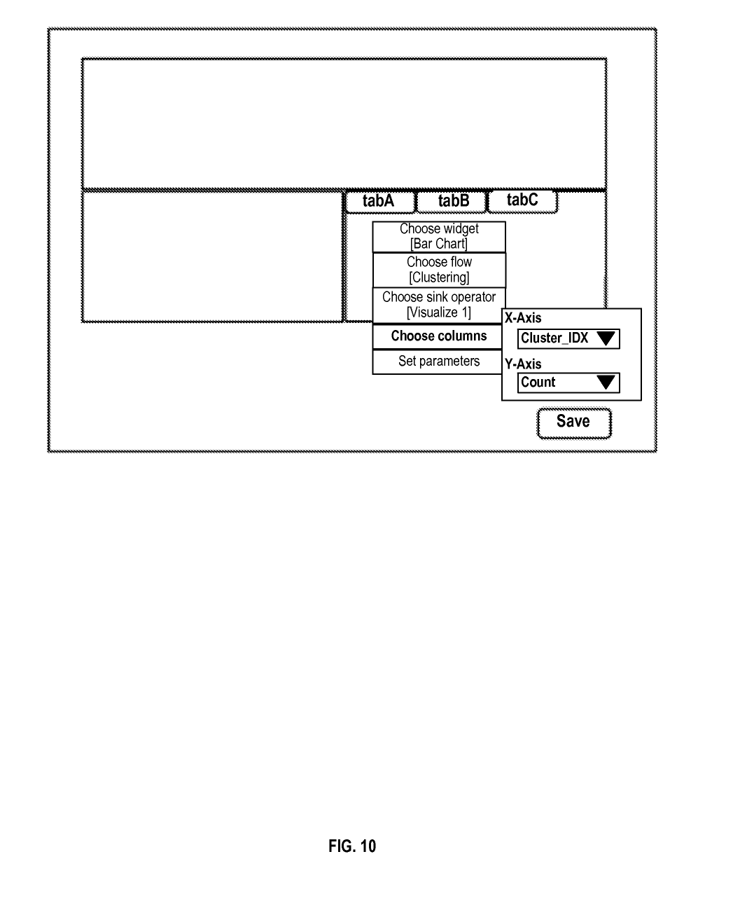

The dashboard designing unit 103-2 facilitates an interface for selection of a “Visualize” node at 1208 that is included in the flow specified in the previous step. The dashboard designing unit 103-2 facilitates the interface so that application builders can choose columns for visualizing the result coming from the “Visualize” node at 1209 and as illustrated in FIG. 10. In the example shown in FIG. 10, a column for x-axis and a column for y-axis are chosen because the application builders selected to have a “Bar Chart” widget.

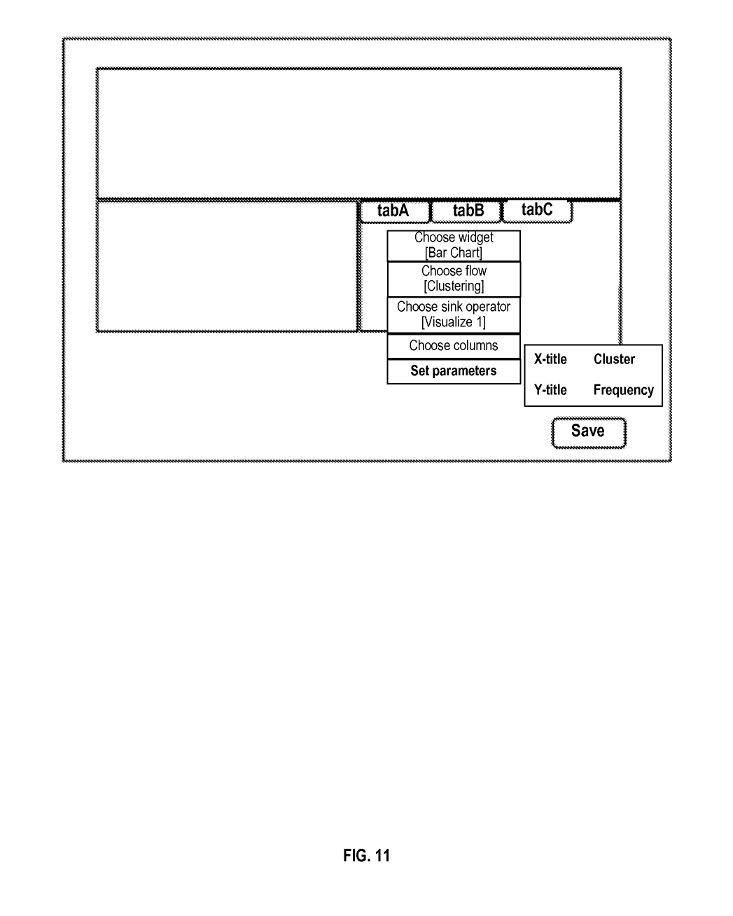

Finally, the application builders set parameters for the widget at 1210 if needed, as illustrated in FIG. 11. For example, in FIG. 11, the dashboard designing unit 103-2 requires axis titles. In other example implementations, the order of operations of configuring widgets can be different depending on the desired implementation.

The dashboard designing unit 103-2 facilitates the method of FIG. 12 until all the panes are set at 1211. If the panes are set (Yes) then the dashboard is saved at 1212 in any format to the metadata store 104-1, otherwise (No) the flow reverts back to 1205.

Thus, by utilizing an interface for the flow building unit 103-1 and an interface for the dashboard designing unit 103-2, an IT developer/domain expert and a design developer can develop their parts individually. The IT developer/domain expert can utilize the interface provided by the flow building unit 103-1 by developing and deploying operators for creating data, and the design developer can utilize the interface provided by the dashboard designing unit 103-2 by developing and deploying widgets for designing the visualization of the data. This facilitates parallel work by IT developers and design developers.

In the application use phase, the application users can see the dashboards built using the processes above when the dashboards are executed through the dashboard execution unit 103-6. The dashboard execution unit executes the flows related to the dashboard that the users want to see, or a flow manager can be used to run the flows. The dashboard execution unit 103-6 takes the dashboard definitions and flow definitions stored in the metadata store 104-1 and shows the visualized results to the users.

From the user of the interface provided by the flow building unit 103-1, and the interface provided by the dashboard designing unit 103-2, the example implementations can consolidate the information into the metadata store 104-1 to provide management information that is used to create and execute the dashboard with the dashboard execution unit 103-6.

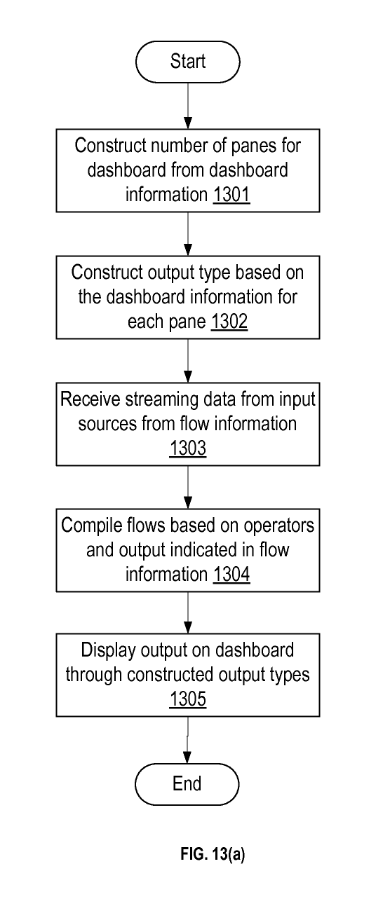

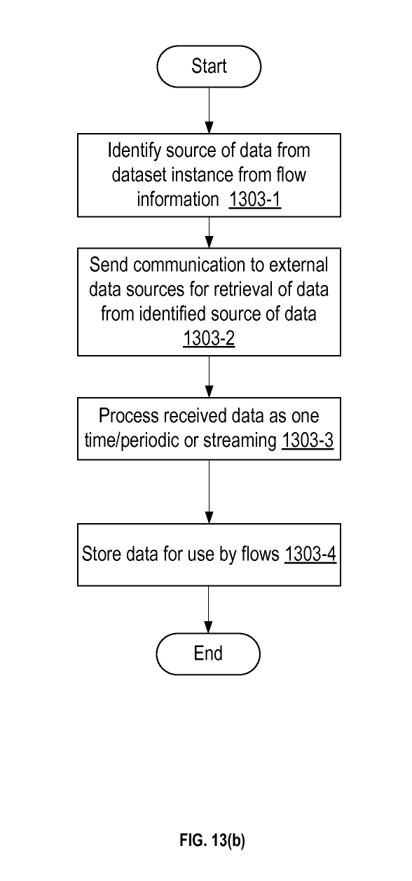

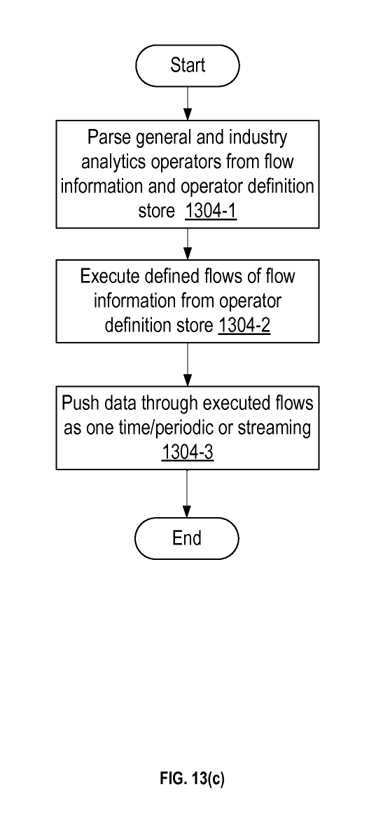

FIG. 13(a) illustrates an example flow for executing the application use phase in accordance with an example implementation. At 1301, upon execution of the dashboard, the dashboard execution unit 103-6 constructs a number of panes for the dashboard based on the dashboard information stored in the metadata store 104-1. At 1302, the output type is determined based on the dashboard information for each pane in the metadata store 104-1 and then constructed for the dashboard by the dashboard execution unit 103-6.

At 1303, streaming data from external input sources is processed as identified by the flow information in the metadata store 104-1 and the flows are executed. Further detail is provided in FIG. 13(b).

At 1304 the flow are compiled based on the operators indicated in the metadata store 104-1. The dashboard execution unit 103-6 parses the analytics operators selected from the operator definition store 104-2, including the operators configured for the general analytics operations and the operators configured for the industry analytics operations from the flow information to execute the flows. Further detail is provided in FIG. 13(c).

At 1305, the output is displayed through the constructed output types. The dashboard execution unit 103-6 present results of the execution of the flows on the generated dashboard. Thus, the dashboard execution unit 103-6 provides a mechanism for the execution of one-time, periodic and streaming flows and for displaying results on the dashboard.

FIG. 13(b) illustrates an example flow for executing the application use phase in accordance with an example implementation. In particular, FIG. 13(b) illustrates an example implementation as to how streaming data from external input sources is processed as identified by the flow information in the metadata store 104-1 as illustrated at 1303 of FIG. 13(a).

At 1303-1, the dashboard execution unit 103-6 identifies the source of data from dataset instance from the flow information in the metadata store 104-1. This is illustrated, for example, in FIG. 14(a), wherein based on the data listed in the dataset instance, the dashboard execution unit 103-6 identifies the appropriate source for the data. For example, if the data is “StreamingProductionData” as illustrated in FIG. 14(a), the dashboard execution unit 103-6 identifies the one or more rig systems managed by the computing device 100 for querying. An example of such a system is provided in FIG. 15. Similarly, if the data source is a historical data set, then the dashboard execution unit 103-6 identifies the appropriate database for use by the rig systems. The identification and association of the dataset instance to the associated source can be conducted by any method in accordance with the desired implementation.

At 1303-2, the dashboard execution unit 103-6 sends a communication to external data sources for retrieval of data based on the sources of data identified from 1303-1. In the example of FIG. 14(a), for the dataset of “StreamingProductionData”, the dashboard execution unit 103-6 sends a communication to the one or more rig systems managed by the computing device 100, and obtains data fed from the sensors of the one or more rig systems. An example of such as system is provided in FIG. 15. Similarly, if the data source is a historical data set, then the dashboard execution unit 103-6 harvests the data from the appropriate database.

At 1303-3, the dashboard execution unit 103-6 tags the data as one time/periodic or streaming 1303-3, which facilitates the dashboard execution unit 103-6 to obtain the data based on the tagging. The dashboard execution unit obtains the tagging information from the metadata store 104-1, where it was defined by the flow building unit 103-1, and as illustrated in FIG. 14(a) for the dashboard information.

At 1303-4, the dashboard execution unit 103-6 stores the received data for use by the flows, wherein the flow can proceed to 1304.

FIG. 13(c) illustrates an example flow for executing the application use phase in accordance with an example implementation. In particular, FIG. 13(c) illustrates an example implementation as to how flows can be compiled as illustrated at 1304 of FIG. 13(a).

At 1304-1, the dashboard execution unit 103-6 identifies the flows defined in the flow information of the metadata store 104-1 and parses the analytics operators selected from the operator definition store 104-2 as identified in the flows of the metadata store 104-1, including the operators configured for the general analytics operations and the operators configured for the industry analytics operations. At 1304-2, when the operators are retrieved from operator definition store 104-2, the dashboard execution unit 103-6 executes the retrieved operators in accordance with the flow defined in the flow information of metadata store 104-1. At 1304-3, based on the tagging of the data from 1303-3, the data is pushed through the flow as a one-time/streaming or periodic manner as defined in the metadata store 104-1. Thus, the flows of the dashboard and the dashboard output can be constantly updated by the input data from the external sources based on the tagging as one time/periodic or streaming. For periodic or streaming implementations, the computing device 100 may retrieve the data based on the period set in the metadata store 104-1 (e.g., once a day, once a week, stream every five minutes, etc.).

FIG. 14(a) illustrates an example of metadata store 104-1, in accordance with an example implementation. Metadata store 104-1 can be managed as management information from which flows and dashboard can be executed. In the example of FIG. 14(a), there is flow information generated through the interface provided by flow building unit 103-1. Examples of information that can be stored as flow information in the metadata store 104-1 include the Flow Name, DataSetInstance, Operator Input, Operator, Operator Output, and ResultInstance. The Flow Name field can indicate the name of the flow for the information constructed through the interface of the flow building unit 103-1. The DataSetInstance field can indicate the external data sources utilized by the flow for streaming data. The Operator Input field indicates inputs to be made to a corresponding operator. The Operator field indicates the operators used on the corresponding Operator Input field or the corresponding DataSetInstance field. The Operator output field indicates the name of the output produced by the corresponding operator in the Operator field. The ResultInstance indicates dashboard writeable output generated from the corresponding operator input and operator.

In the example of FIG. 14(a), there is also dashboard information generated through the interface provided by dashboard designing unit 103-2. Examples of information that can be stored as dashboard information can include the Dashboard Name, the template configuration, output type for panes in the dashboard, type of data being output (one time, periodic, streaming) and output sources for the output types. The output sources can be external data sources indicated in DataSetInstance in the flow information, results provided in ResultInstance from the flow information, or other external sources depending on the desired implementation. Other variations of FIG. 14(a) for flow information and dashboard information are also possible depending on the desired implementation, and the present disclosure is not limited to the example of FIG. 14(a). For example, metadata store 104-1 can also include the location of the data sources (e.g., name of database, specific nodes, etc.), as well as the definition of the time periods used for retrieving periodic or streaming data (e.g., once a day, stream every five minutes, etc.). The type of data being output can also be managed in the flow information part of the metadata store 104-1 instead of the dashboard information. Other elements of the flow information and the dashboard information are also interchangeable depending on the desired implementation.

FIG. 14(b) illustrates an example of an operator definition store, in accordance with an example implementation. The library of pre-existing operators can be managed in the operator definition store 104-2, to include the general analytics operations and industry analytics operations. In the abstracted example of FIG. 14(b), the fields can include the name of the operators, the operator type, the input type, and the function of the operator. The operator type can indicate if it is a general analytics operator (e.g., from a library) or an industry specific operator (e.g., defined by an application builder for the desired industry), an input type to define the input parameters of the operators, and the function of the operator (defined abstractly or as a concrete function depending on the desired implementation).

FIG. 15 illustrates an example system upon which example implementations may be implemented. In the example of FIG. 15, the computing device 100 is communicatively connected to a network 1500 that is also connected to one or more sources of data. In the example of FIG. 15, the one or more sources of data are rig systems. The one or more rig systems 1501-1, 1501-2, 1501-3, 1501-4, and 1501-5 can involve a corresponding rig 1520-1, 1520-2, 1520-3, 1520-4, 1520-5 along with a corresponding rig node 1530-1, 1530-2, 1530-3, 1530-4, and 1530-5. Computing device 100 also manages a database 1503 which contains data aggregated from the rig systems in the network. In alternate example implementations, the data from the rig systems can be aggregated to a central repository or central database such as public databases that aggregate data from rigs or rig systems for government compliance purposes, and the computing device 100 can access or retrieve the data from the central repository or central database.

Rig nodes 1530-1, 1530-2, 1530-3, 1530-4, and 1530-5 can behave as external data sources and obtain live or recorded data from the operations of rigs 1501-1, 1501-2, 1501-3, 1501-4, and 1501-5 which is streamed to the computing device 100. Examples of such data can include, but is not limited to, oil production levels, drilling parameters, and so forth. Thus the computing device can execute flows in the background for the interface of flow building unit 103-1 so that the application builder can view results, as well as provide the external stream or database data for the dashboards executed by dashboard execution unit 103-6. In another example implementation, after dashboard execution unit 103-6 compiles and executes the dashboard from metadata store 104-1, dashboard execution unit 103-6 streams the data from the rig nodes associated with the dashboard. Although the example provided in FIG. 15 is directed to a shale gas rig operation, other systems can also be utilized depending on the desired implementation, and the present disclosure is not limited to shale gas rig operations. Other example implementations can include data networks, power grid management, truck and dump site management, and any other system involving data that can be streamed to the computing device 100.

Finally, some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. An apparatus communicatively coupled to a network and one or more sources, the apparatus comprising:
a storage configured to store flow information and dashboard information; and
a processor, configured to:
provide a first user interface configured for construction of the flow information representative of a plurality of flows, the plurality of flows comprising a plurality of analytics operators selected from a library of pre-existing operators through the first user interface, the library of pre-existing operators comprising a first type of operator configured for general analytics operations, and a second type of operator configured for industry analytics operations;
provide a second user interface configured to generate the dashboard information to handle the plurality of flows;
generate a dashboard from the dashboard information and the flow information, the dashboard configured to be constantly updated from streaming or periodic input from the one or more sources;
parse the plurality of analytics operators selected from the first type of operators configured for the general analytics operations and the second type of operators configured for the industry analytics operations from the flow information to execute the plurality of flows; and
present results of the execution of the plurality of flows on the generated dashboard.

2. The apparatus of claim 1, wherein the processor is configured to provide a second user interface configured to generate the dashboard information by: providing a widget selection user interface; providing a flow selection user interface; providing an output operator user interface; and providing a widget configuration user interface.

3. The apparatus of claim 1, wherein the industry analytics operations comprises at least one of: predictive maintenance, operation optimization, production monitoring, supply chain optimization, and production optimization.

4. The apparatus of claim 1, wherein the processor is configured to provide a library management utility configured to manage the pre-existing operators of the library and to add new operators.

5. The apparatus of claim 1, wherein the processor is configured to provide a template management utility configured to manage dashboard configuration templates through the second user interface;

6. The apparatus of claim 1, wherein the first user interface is configured to display results of the flow being configured in the first user interface;

7. The apparatus of claim 1, wherein the processor is further configured to provide a mechanism for execution of one-time, periodic and streaming flows and displaying results on the dashboard.

8. A method comprising:
providing a first user interface configured for construction of flow information representative of a plurality of flows, the plurality of flows comprising a plurality of analytics operators selected from a library of pre-existing operators through the first user interface, the library of pre-existing operators comprising a first type of operator configured for general analytics operations, and a second type of operator configured for industry analytics operations;
providing a second user interface configured to generate dashboard information to handle the plurality of flows;
generating a dashboard from the dashboard information and the flow information, the dashboard configured to be constantly updated from streaming or periodic input from one or more sources;
parsing the plurality of analytics operators selected from the first type of operators configured for the general analytics operations and the second type of operators configured for the industry analytics operations from the flow information to execute the plurality of flows; and
presenting results of the execution of the plurality of flows on the generated dashboard.

9. The method of claim 8, wherein the providing a second user interface configured to generate the dashboard information comprises: providing a widget selection user interface; providing a flow selection user interface; providing an output operator user interface; and providing a widget configuration user interface.

10. The method of claim 8, wherein the industry analytics operations comprises at least one of: predictive maintenance, operation optimization, production monitoring, supply chain optimization, and production optimization.

11. The method of claim 8, further comprising providing a library management utility configured to manage the pre-existing operators of the library and to add new operators.

12. The method of claim 8, wherein the instructions further comprise providing a template management utility configured to manage dashboard configuration templates through the second user interface;

13. The method of claim 8, wherein the first user interface is configured to display results of the flow being configured in the first user interface.

14. The method of claim 8, further comprising providing a mechanism for execution of one-time, periodic and streaming flows and displaying results on the dashboard.

15. A computer program, storing instructions for executing a process, the instructions comprising:
providing a first user interface configured for construction of flow information representative of a plurality of flows, the plurality of flows comprising a plurality of analytics operators selected from a library of pre-existing operators through the first user interface, the library of pre-existing operators comprising a first type of operator configured for general analytics operations, and a second type of operator configured for industry analytics operations;
providing a second user interface configured to generate dashboard information to handle the plurality of flows;
generating a dashboard from the dashboard information and the flow information, the dashboard configured to be constantly updated from streaming or periodic input from one or more sources;
parsing the plurality of analytics operators selected from the first type of operators configured for the general analytics operations and the second type of operators configured for the industry analytics operations from the flow information to execute the plurality of flows; and
presenting results of the execution of the plurality of flows on the generated dashboard.
